(19) United States
(12) Patent Application Publication
(10) Pub. No.: US 2008/0204888 A1
(43) Pub. Date: Aug. 28, 2008

(54) Optical system for luminaire

(76) Inventors: Peter Kan, North Vancouver (CA); George E. Matheson, North Vancouver (CA); Kwong Man, Vancouver (CA); Adrian Weston, New Westminster (CA)

Correspondence Address: PHILIPS INTELLECTUAL PROPERTY & STANDARDS, 3 BURLINGTON WOODS DRIVE, BURLINGTON, MA, 01803, US

(21) Appl. No.: 12/070,530

(22) Filed: Feb. 19, 2008

(30) Foreign Application Priority Data
Feb. 16, 2007 (CA) 2578896

(51) Int. Cl. G02B 27/14; F21V 7/00

(52) U.S. Cl. 359/629; 362/297

(57) ABSTRACT

An optical system for mixing and redirecting light generated by a light source is provided. The optical system comprises a first reflector operatively disposed relative to the light source, the first reflector configured to receive first light emitted by the light source which propagates along lines of sight therebetween and configured to reflect the first light as second light; a diffuser for scattering light incident thereon, the diffuser and the first reflector configured so that second light is incident upon the diffuser, wherein the incident light is diffused as third light and wherein the third light is directed towards the target surface; a second reflector operatively disposed and aligned relative to the diffuser and the first reflector is configured to direct light towards the target surface, thereby illuminating the target surface.

### FIELD OF THE INVENTION

The present invention pertains to the field of lighting and in particular to an optical system for mixing and redirecting light.

### BACKGROUND

Advances in the development and improvements of the luminous flux of light-emitting devices such as solid-state semiconductor and organic light-emitting diodes (LEDs) have made these devices suitable for use in general illumination applications, including architectural, entertainment, and roadway lighting. Light-emitting diodes are becoming increasingly competitive with light sources such as incandescent, fluorescent, and high-intensity discharge lamps.

Space lighting provides for many challenges. One such challenge is to design a luminaire that can provide light that illuminates a surface so that the light originating from the luminaire which is reflected from the surface or which is transmitted through the surface makes the surface appear in a predetermined way. This may include luminaires that are designed to be set up on a wall or proximate an edge of a wall and that are used to illuminate one or more large portions of the wall in an increasingly grazing-incident fashion with increasing distance from the luminaire while generating even illumination conditions across the whole illuminated portion of the wall. In particular, this problem is related to being capable of illuminating portions of an illuminated surface that are relatively proximate to the luminaire so they appear as bright as portions that are relatively distant to the luminaire. With particular regard to multi-color LED-based luminaires, a further requirement is the need for effective colour mixing of the light emitted by the different-colour light sources in order to make the illuminated surface appear, for example, uniformly or otherwise coloured or white-lighted with a desired correlated colour temperature (CCT).

Known luminaire designs for illuminating large areas of nearby objects, for example, a wall, a screen, a facade or a curtain, in a grazing-incident fashion are often operatively disposed near an edge of the object, for example, proximate an edge between a ceiling and a wall, a wall and a floor, or a wall and another wall. Luminaires for this purpose are typically elongate in shape, can be surface or recess mounted and include an optical system. The use of an optical system, and the relative positioning and alignment of the components of the optical system and the light sources in the luminaire provide the ability to design luminaires with greater flexibility for beam shaping and light mixing. A great number of luminaires are known that employ optical systems of various designs and combinations that are also useful for surface illumination by grazing incident. International Patent Publication No. WO2006/126114, U.S. Pat. Nos. 6,995,355, 6,965,205, 6,808,299, 6,601,970, 6,257,737, 6,220,731, 5,727,870 and Japanese Patent No. 2002-216518, provide examples. Further examples are provided by LED Linear Wall Washer products from the evo™ series of Renaissance Lighting Inc. of which brochures are obtainable via http://www.renaissancelighting.com or by the Recessed Wall Washer products from the NWW series of LSI Industries Inc. of which brochures are obtainable via http://www.lsi-industries.com.

FIG. 1 schematically illustrates a cross-sectional view of a luminaire 200 according to a known design for wall illumination. The luminaire includes one or more LEDs 2 (only one LED is illustrated) and an optical system. The optical system includes a reflector 3 and a diffuser 4 and can be configured to illuminate a predetermined portion of wall 100 in a predetermined way. The luminaire can be positioned so the LEDs 2 are disposed in a plane parallel to and separated by a distance 11 from wall 100. The distance 11 and the properties of surface 5 can determine the illumination generated by the luminaire. The overall fitness of this type of luminaire for wall illumination is limited.

FIG. 2 schematically illustrates a cross-sectional view of luminaire 300 according to another known design for wall illumination. The luminaire includes a specular reflective element 320 positioned proximate below the LEDs 2 for blocking a direct line of sight between the diffuser and the LEDs. The reflective element 320 can suppress excessive hot spots on a proximate portion of an illuminated surface but wastes light when used for wall illumination by also illuminating the floor.

These known luminaire systems, however, often generate undesired hot spots or color spots or other undesired variations in brightness or chromaticity of the illuminated surface. Known luminaire systems also often generate disturbing visual impressions when viewed directly or waste light by illuminating areas other than the intended surface, for example, a ceiling-mounted luminaire for illuminating the adjacent wall that also illuminates the floor. The undesired lighting effects caused by these luminaire systems often arise from the configuration of the employed optical systems.

Therefore there is a need for a new optical system for luminaires that at least overcomes one of the disadvantages of existing systems.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide an optical system for luminaires. In accordance with an aspect of the present invention, there is provided an optical system for mixing and redirecting light generated by a light source, the light source disposed and oriented in a predetermined way, the optical system for illuminating a target surface, the optical system comprising: a first reflector operatively disposed relative to the light source, the first reflector configured to receive first light emitted by the light source under operating conditions, the first light propagating from the light source to the reflector, the first reflector configured to reflect a portion of the first light as second light; a diffuser for scattering light incident thereon, the diffuser operatively disposed and aligned relative to the first reflector, the diffuser and the first reflector configured so that at least a portion of the second light is incident upon the diffuser and is transmitted thereby as third light, the diffuser directing a portion of the third light towards the target surface; a second reflector operatively disposed and aligned relative to the diffuser and the first reflector, said second reflector configured to reflect light towards the target surface; wherein the optical system is disposed and aligned relative to the target surface in a predetermined way and configured for providing predetermined illumination to the target surface.

In accordance with another aspect of the present invention there is provided a luminaire for illuminating a target surface, the luminaire comprising: one or more light-emitting elements (LEEs), the LEEs disposed and oriented in a predetermined way; a first reflector operatively disposed relative to the LEEs, the first reflector configured to receive first light emitted by the LEEs under operating conditions, the first light propagating from the LEEs to the reflector, the first reflector configured to reflect a portion of the first light as second light; a diffuser for scattering light incident thereon, the diffuser operatively disposed and aligned relative to the first reflector, the diffuser and the first reflector configured so that at least a portion of the second light is incident upon the diffuser and is transmitted thereby as third light, the diffuser directing a portion of the third light towards the target surface; a second reflector operatively disposed and aligned relative to the diffuser and the first reflector, said second reflector configured to reflect light towards the target surface; wherein the luminaire is disposed and aligned relative to the target surface in a predetermined way and configured for providing predetermined illumination to the target surface.

### BRIEF DESCRIPTION OF THE FIGURES

FIG. 1 illustrates a cross-sectional view of a prior art luminaire.

FIG. 2 illustrates a cross-sectional view of another prior art luminaire.

FIG. 3 schematically illustrates a number of example setups of luminaires that may employ optical systems according to embodiments of the present invention.

FIG. 4 illustrates a cross-sectional view of a luminaire including an optical system according to an embodiment of the present invention.

FIG. 5 illustrates schematically a perspective view of a first reflector in combination with LEEs for use in embodiments of the present invention.

FIG. 6A illustrates a first reflector according to an embodiment of the present invention.

FIG. 6B illustrates a first reflector according to another embodiment of the present invention.

FIG. 7 illustrates an array of six groups of four LEEs each with different color LEEs per group for use in luminaire including optical systems according to an embodiment of the present invention.

FIG. 8 illustrates an array of eight groups of four LEEs each with different color LEEs per group for use in luminaire including optical systems according to an embodiment of the present invention.

FIG. 9A illustrates an example array comprising a linear symmetrical periodic arrangement of multi-color LEEs for use in luminaire including optical systems according to an embodiment of the present invention.

FIG. 9B illustrates an example array comprising a linear non-symmetrical periodic arrangement of multi-color LEEs for use in luminaire including optical systems according to an embodiment of the present invention.

FIG. 10A illustrates an example of an array of multi-color LEEs for use in luminaire including optical systems according to an embodiment of the present invention.

FIG. 10B illustrates an example of an array of multi-color LEEs for use in luminaire including optical systems according to another embodiment of the present invention.

FIG. 11A illustrates a schematic cross-sectional view of a luminaire according to an embodiment of the present invention.

FIG. 11B illustrates vertical and horizontal illumination profiles for the luminaire illustrated in FIG. 11A.

FIG. 12A illustrates a cross-sectional view of a luminaire according to another embodiment of the present invention.

FIG. 12B illustrates vertical and horizontal illumination profiles for the luminaire illustrated in FIG. 12A.

FIG. 13A illustrates a cross-sectional view of a luminaire according to another embodiment of the present invention.

FIG. 13B illustrates vertical and horizontal illumination profiles for the luminaire illustrated in FIG. 13A.

FIG. 14A illustrates a cross-sectional view of a luminaire according to another embodiment of the present invention.

FIG. 14B illustrates vertical and horizontal illumination profiles for the luminaire illustrated in FIG. 14A.

FIG. 14C illustrates a cross-sectional view of the luminaire illustrated in FIG. 13A.

FIG. 15A illustrates a cross-sectional view of a luminaire according to another embodiment of the present invention.

FIG. 15B illustrates vertical and horizontal illumination profiles for the luminaire illustrated in FIG. 15A.

FIG. 15C illustrates a cross-sectional view of the luminaire illustrated in FIG. 13A.

FIG. 16A illustrates a cross-sectional view of a luminaire according to another embodiment of the present invention.

FIG. 16B illustrates vertical and horizontal illumination profiles for the luminaire illustrated in FIG. 16A.

FIG. 16C illustrates a cross-sectional view of the luminaire illustrated in FIG. 13A.

FIG. 17 illustrates an end view of a luminaire including an optical system according to another embodiment of the present invention.

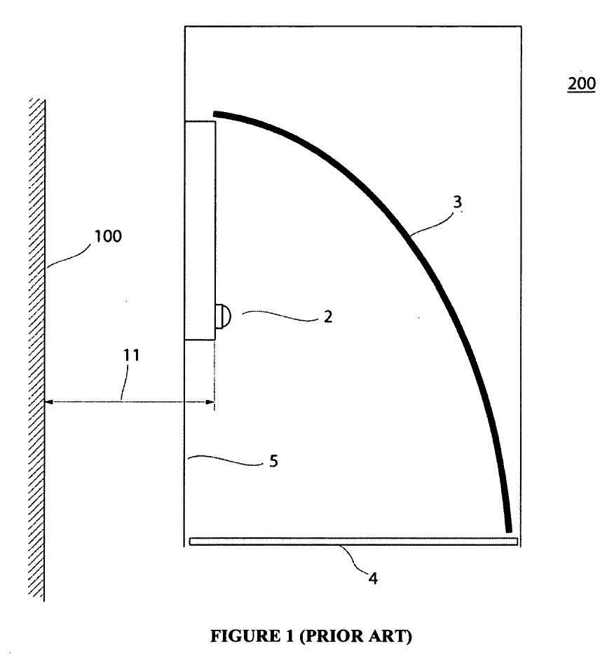

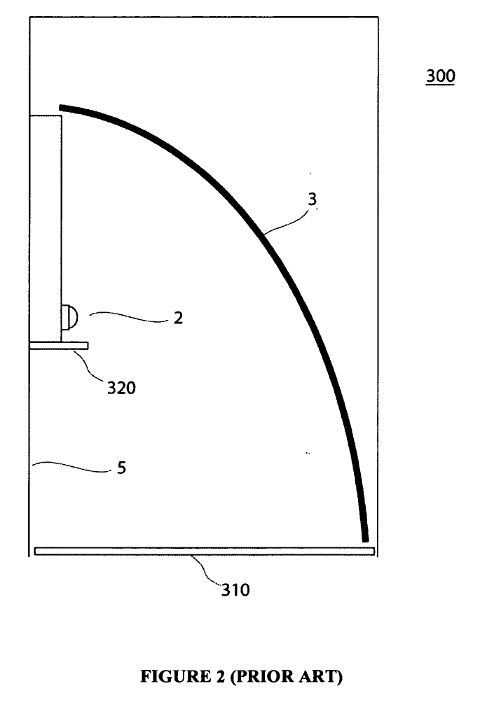

### DETAILED DESCRIPTION OF THE INVENTION

### Definitions

The term “light-emitting element” (LEE) is used to define a device that emits radiation in a region or combination of regions of the electromagnetic spectrum for example, the visible region, infrared and/or ultraviolet region, when activated by applying a potential difference across it or by passing an electrical current through it, for example. An LEE can have monochromatic, quasi-monochromatic, polychromatic or broadband spectral emission characteristics. Examples of LEEs include semiconductor, organic, or polymer/polymeric light-emitting diodes, optically pumped phosphor coated light-emitting diodes, optically pumped nano-crystal light-emitting diodes or other similar devices as would be readily understood by a worker skilled in the art. Furthermore, the term light-emitting element is used to define the specific device that emits the radiation, for example a LED die, and can equally be used to define a combination of the specific device that emits the radiation together with a housing or package within which the specific device or devices are placed.

The term “color” is used to define a perceivable characteristic of light and may be, used interchangeably to identify a certain range of chromaticities, for example, or, as the case may be, it may be understood colloquially, including, red, green, blue, orange, purple etc, for example.

As used herein, the term “about” refers to a ±10% variation from the nominal value. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

The present invention provides an optical system for mixing and redirecting light generated by light source that is disposed and oriented in a predetermined way for illuminating a target surface. The optical system comprises a first reflector operatively disposed relative to the light source, the first reflector configured to receive first light emitted by the light source under operating conditions, the first light propagating from the light source to the reflector, the first reflector configured to reflect a portion of the first light as second light. The optical system further comprises a diffuser for scattering light transmitted by the diffuser relative to light incident on the diffuser, the diffuser operatively disposed and aligned relative to the first reflector, the diffuser and the first reflector configured so that at least a portion of the second light is incident upon the diffuser, the diffuser transmitting at least a portion of the incident light as third light, the diffuser directing a portion of the third light towards the target surface. Moreover, the optical system comprises a second reflector operatively disposed and aligned relative to the diffuser, the second reflector, the diffuser and the first reflector configured so that a portion of the second and/or third light is reflected by the second reflector towards the target surface. The optical system, when disposed and aligned relative to the target surface in a predetermined way, is configured to provide a predetermined illumination to the target surface.

Optical systems according to embodiments of the present invention can be employed in luminaires, for example, in LEE-based luminaires, or in multi-color LEE-based luminaries, or other light source configured luminaries, as would be readily understood by a worker skilled in the art. According to embodiments of the present invention, an optical system can be configured to mix the light generated by the LEEs to provide illumination of a desired intensity or color or both at a target surface. The target surface can be a planar area of desired size, distance and relative orientation such as a wall or a ceiling or a portion of a wall or a ceiling, for example. The target surface may be illuminated in a predetermined way, for example, to generate an illumination with a homogenous or inhomogenous brightness or color profile.

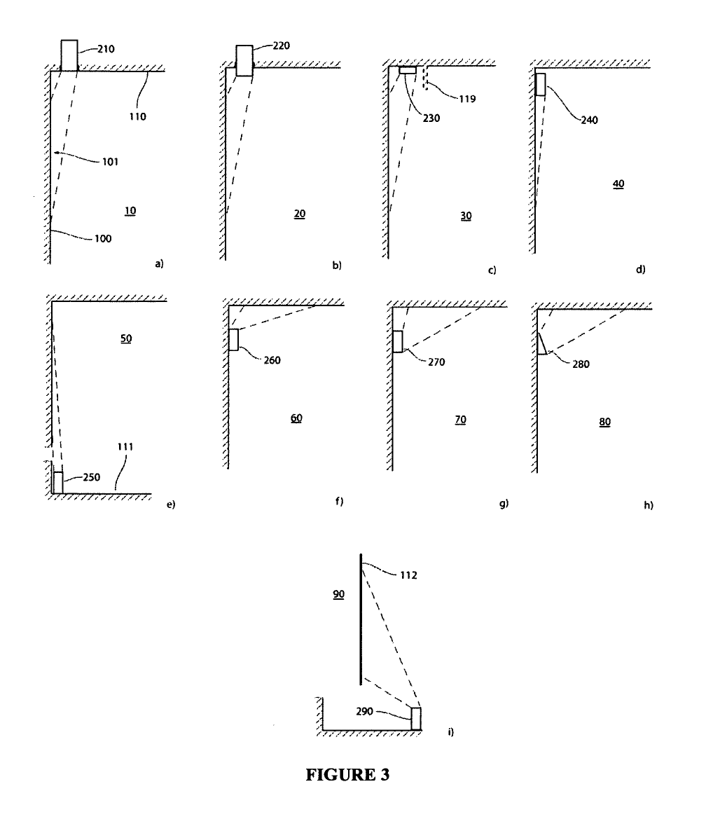

FIG. 3 schematically illustrates cross-sectional views of a number of setups of luminaires that employ optical systems according to different embodiments of the present invention. Luminaires may have different decorative designs (not illustrated). FIG. 3A illustrates setup 10 in which luminaire 210 is recessed in a ceiling 110 for illumination of a surface 101 on a wall 100. Luminaire 210 is fully recessed and its lower end may be flush with the surface of the ceiling. FIG. 3B illustrates setup 20 of a luminaire 220 that is similarly but only partially recessed in the ceiling. A lower portion of luminaire 220 partially protrudes the ceiling. FIG. 3C illustrates setup 30 of a ceiling-mounted luminaire 230. Luminaire 230 is surface mounted to the ceiling. The set-up may additionally comprise an optional decorative blind 119 to obscure luminaire 230 from direct viewing from certain observation angles. FIG. 3D illustrates setup 40 of a wall-mounted luminaire 240. Luminaire 240 is configured to provide wall-illumination. FIG. 3E illustrates setup 50 of luminaire 250 which may be disposed proximate to floor 111. Luminaire 50 is configured to provide wall illumination. FIG. 3F illustrates setup 60 of a wall-mounted luminaire 260 for ceiling illumination. Luminaire 260 is configured to emit light for ceiling illumination through a top side of the luminaire. FIG. 3G illustrates setup 70 of another wall-mounted luminaire 270 for ceiling illumination. Luminaire 270 is configured to emit light for ceiling illumination through a side opposite the wall. FIG. 3H illustrates setup 80 of further wall-mounted luminaire 280 for ceiling illumination. Luminaire 280 is configured to emit light for ceiling illumination also through a side opposite the wall. Luminaire 280 is differently configured than luminaire 270 in that the side opposite the wall through which it emits light for ceiling illumination is reclined towards the ceiling at a predetermined angle. FIG. 3I illustrates a setup 90 of a floor-operated luminaire 290 for illuminating a hanging or otherwise supported screen or other to-be-illuminated surface 112. Floor-operated luminaire similar to luminaire 290 may be configured with reclined sides facing the to-be-illuminated surface similar to luminaire 280 of setup 80.

It is noted that, while FIG. 3 illustrates example setups of different luminaires, each with an optical system according to an embodiment of the present invention for illumination of a surface located at one side of the luminaire, optical systems according to embodiments of the present invention may be employed in luminaires that may be used to illuminate surfaces located at two or more sides of a particular luminaire, for example at opposite sides. It is further noted that, while FIG. 3 illustrates setups of luminaires each with an optical system according to an embodiment of the present invention in cross section, a luminaire or the optical system employed in the luminaire according to the present invention may be elongated, point-like, tubular, spherical or otherwise as would be readily understood by a person skilled in the art.

Employing light sources such as LEE in combination with an optical system, for example, through the use of reflectors, permits designing luminaires with greater flexibility in beam shaping and light mixing than a luminaire that relies on direct illumination only. Adequately configured optical systems can reduce otherwise perceivable brightness or color variations of illuminated surfaces or when directly viewing the luminaire.

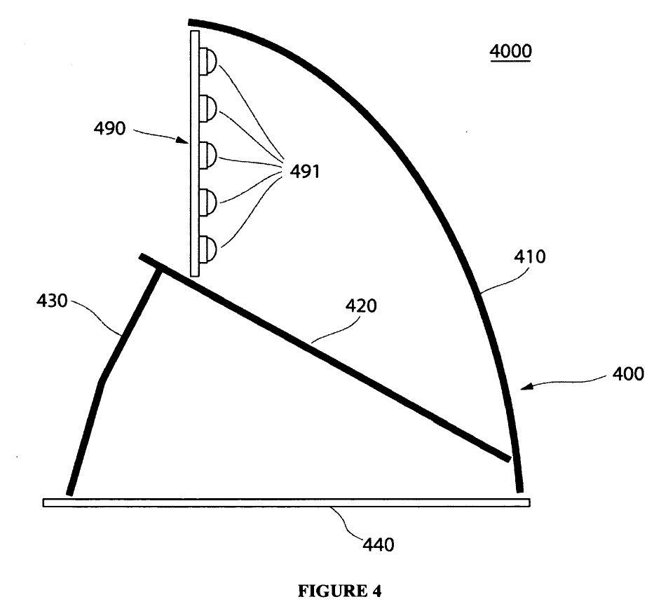

FIG. 4 illustrates a cross-sectional view of an elongate luminaire 4000 including an optical system 400 according to an embodiment of the present invention. The luminaire comprises one or more arrays 490 of a predetermined number of LEEs 491. While there are five LEEs illustrated, it is noted that luminaires according to the present invention can comprise any number of LEEs such as one or more. The optical system comprises a first reflector 410, a diffuser 420 and a second or kick-reflector 430 which are disposed as illustrated. The optical system may optionally comprise an optically transparent or translucent cover element 440 for purposes of protecting the optical system or for providing a predetermined appearance or both. The cover element 440 may additionally provide predetermined diffusing or refracting functions. Other examples of optical system are discussed below. The luminaire 4000 is configured to be set up so that the LEEs 491 are facing away from the to-be-illuminated surface.

Generally, a portion of the light emitted by the LEEs 491 under operating conditions is directly directed towards the reflector 410 along unobstructed lines of sight between the LEEs 491 and the reflector. Another portion of the light emitted by the LEEs 491 is directly directed towards the diffuser 420. It is noted that different optical systems according to different embodiments of the present invention may directly direct different portions of light towards the reflector 410 and the diffuser 420 in different proportions. Optical systems according to embodiments of the present invention may be configured so that substantially no relevant amount of light that is emitted by the LEEs is directly directed towards the diffuser.

The optical system 400 is configured so that the reflector 410 reflects substantially all light that is emitted by the LEEs 491 that propagates along lines of sight and is incident upon the reflector towards the diffuser. The diffuser 420 is configured to transmit the light that is incident upon it and to scatter the light that it transmits relative to the incident light.

The second reflector 430 can be configured to direct light to further away portions of the illuminated surface. It can be configured to reduce overly bright illumination at relatively proximate portions of the illuminated surface.

### Reflectors

The reflectors can comprise one or more reflective elements which can be configured in one or more of shapes. For example, each reflector can be configured to provide a reflective surface that can have a parabolic, hyperbolic, planar, elliptical, an arc of a circle or other curved or segmented cross-section or other shape as would be readily understood by a person skilled in the art. In one embodiment, the reflector can be elongated having a finite extension. In addition, in embodiments of the present invention, the reflective surfaces can be faceted. It is understood that the reflector elements can be configured to determine the level of light mixing provided by the optical system.

The shapes of the reflective surfaces provided by the first or the second reflector have an effect, at least in part, on the light output of the optical system. Furthermore, the light output of the optical system together with the position and orientation relative to a target surface determine the illumination pattern of the target surface. From a design perspective, a predetermined illumination pattern of the target surface determines characteristic parameters of the optical system as well as type, number and disposition of LEEs, and useful distances, alignments and orientations of components of the optical system and the optical system relative to the target surface. During design of the optical system, the type, number and disposition of the LEEs may be predetermined or may be determined in combination with the optical system. Characteristic parameters of the reflective surfaces of the first and the second reflector include the extension, alignment, curvature and reflectivity of the first and second reflector as well as the relative alignment of the reflective surfaces to the other components of the optical system and the LEEs, for example.

The first and second reflectors are configured to provide adequately reflective surfaces for reflecting light. Specifically the reflectors are configured to provide adequate reflection for the light that directly, without prior reflections or transmissions, originates from the LEEs. The reflective surfaces may be configured to provide a number of predetermined shapes. The reflective surfaces may be curved or planar, or they may comprise a predetermined number of curved or planar segments. According to one embodiment of the present invention, the optical system is elongated and the reflective surfaces of the reflectors may be configured to be symmetric under certain predetermined translations within the length of the respective reflector along a first axis that is typically parallel to the length of the optical system.

Each reflector may be configured so that a cross section of its reflective surface is symmetric under continuous or discrete translations along the first axis. Each reflector may, independently of the other, provide a reflective surface that is invariant under continuous translations along the first axis.

According to one embodiment of the present invention, the reflector can comprise two or more segments for adequately directing light emitted by the LEEs. For example, the reflector can comprise an edge-ray segment and an involute segment. The edge-ray segment can be designed for shaping the desired illumination pattern on a lit surface. The involute segment can be designed to redirect light towards the edge-ray segment that the LEEs would otherwise emit away from the edge-ray segment. The involute segment can be a planar reflective element including a preconfigured angle along an edge with the edge-ray segment. The edge-ray segment can be configured to desirably illuminate a wall based on the size and geometry of the wall and the LEE intensity. The involute segment acts as a primary redirecting element for reflecting light back at the edge-ray segment that would otherwise be propagating away from the desired direction of light emission.

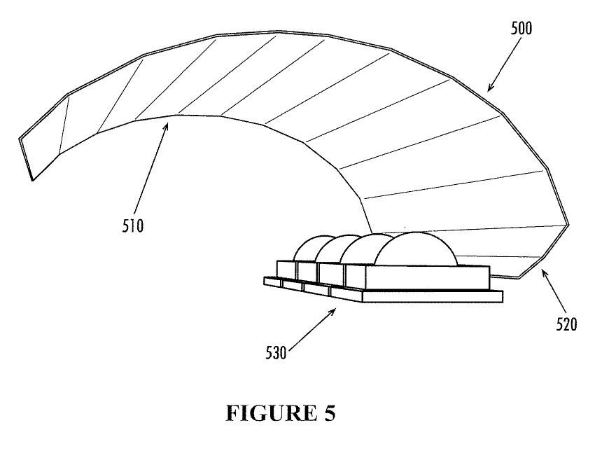

FIG. 5 illustrates an example of an elongated first reflector 500 for use in an optical system according to one embodiment of the present invention. The reflector 500 has two segments, an edge-ray segment 510 and an involute segment 520. The reflector 500 has a cross section that is invariant under continuous translations along its length. The edge-ray segment 510 and the involute segment 520 are configured to provide adequate reflection of light that is emitted from the LEEs 530 under operating conditions and directly incident on the reflector 500.

According to another embodiment of the present invention, the optical system may comprise a first or a second reflector that provides a reflective surface that may be segmented into a predetermined number of reflective elements of predetermined width parallel or perpendicular or both parallel and perpendicular to the first axis. The segments may have equal or unequal width and a length.

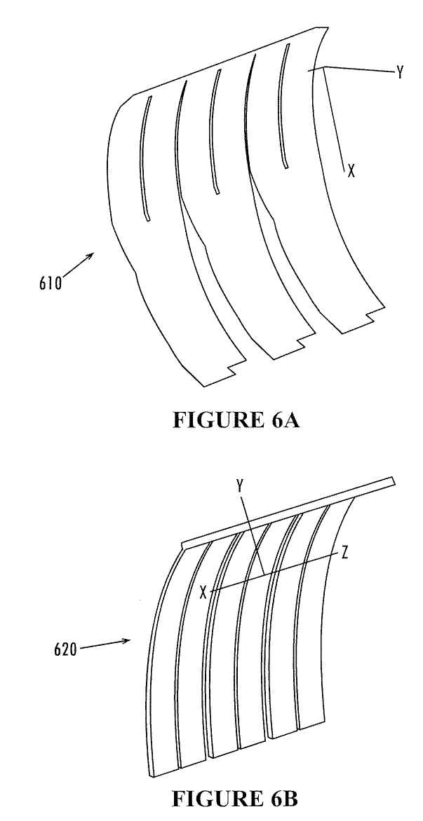

FIG. 6A illustrates an example of an elongated first reflector 610 that is segmented both parallel and perpendicular to the axis of its length according to one embodiment of the present invention. First reflector 610 provides a predetermined number of reflector elements of nominally equal width along the length of the first reflector. The cross section of each reflector element comprises a predetermined number of segments that each may be straight or curved so as to substantially optimally reflect light from the LEEs with different beam distributions. It is noted that one curved segment may be approximated by a predetermined number of flat segments. Such a segmentation may be configured in one dimension only or in two dimensions in a number of different ways as would be readily known by a worker skilled in the art.

First reflector 610 provides an example of a first reflector that provides a reflective surface that has a cross section which is invariant under certain discrete translations along the length of the first reflector. FIG. 6B illustrates another example of an elongated first reflector 620 that comprises both parallel and perpendicular curved segments but with reflector elements that have the same nominal cross section.

According to embodiments of the present invention, the second reflector may be similarly segmented or comprise only one single segment. For example, the second reflector may be configured to provide a straight or kinked cross section as illustrated in FIG. 4 or otherwise shaped cross section. Optical systems according to different embodiments of the present invention may employ differently shaped second reflectors.

The first and the second reflector can be made of a material with a suitable reflective surface. The reflective surfaces may be configured to be specular, Lambertian or otherwise reflective as would be readily understood by a worker skilled in the art. The reflective surface of the first reflector may be different from that of the second reflector. The reflective properties of the surfaces may be isotropic, homogenous, anisotropic, inhomogenous or a combination thereof and can have reflective properties that can range from ideal diffuse to semi specular to ideal specular.

In one embodiment of the present invention, the reflectors can have a finish that is configured to provide reflection that has an isotropic bidirectional reflectance distribution. For example, reflective surface that is similar to or can be generated by peening can improve light-mixing from two or more LEEs. Generally, high reflectivity reduces absorptive losses. The reflector can comprise prefabricated peened material such as Miro 9® or brushed reflective material such as Miro 5® or the like, for example. The reflector can also comprise reflective surfaces of peened, brushed, sanded, etched or otherwise treated material surfaces or combinations thereof or other adequate material surfaces as would be readily known by a person skilled in the art.

In one embodiment of the present invention, the reflective elements of the reflector are fabricated from a reflective material, for example specular reflective aluminum, a metallised plastic or other form of reflective material as would be readily understood by a worker skilled in the art. As an example, reflective elements fabricated from a specular reflective metal or metal-based material, for example, aluminum or aluminum-based material can reflect up to about 95% or more light or intensity.

### Diffuser

The diffuser provides the ability to transmit light and scatter the transmitted light by altering the direction of propagation of the transmitted light relative to that of the incident light. The scattering provided by the diffuser may be random or pseudo-random. The scattering or diffusion of transmitted light can be employed to provide for improved light mixing from spatially separated discrete LEEs.

The diffuser may comprise a refractive optical element, for example, a lenticular array or other optical element as would be readily known to a person skilled in the art. The diffuser can have one or more textured surfaces or interfaces that may be peened, printed, brushed, sanded, etched or otherwise manufactured as would be readily known by a person skilled in the art. The diffuser may comprise adequate diffusing material, for example, Lexan 8A35™, Solite™, Meso™ or holographic material or other adequate material known to a person skilled in the art.

A suitable diffuser can provide adequate wall illumination across a wide range of distances from the optical system. The diffusion characteristics of the diffuser may be isotropic, homogenous, anisotropic, inhomogeneous or a combination thereof. A diffuser with a brushed texture parallel to an axis along which LEEs may be disposed can provide improved color and intensity mixing for luminaires that include multi-color LEEs and so provide good uniform illumination.

The shape of the refractive surfaces and the composition of materials employed in the diffuser can be determined based on the desired light output of the optical system and the type, disposition, alignment and the range of operating conditions of the LEEs.

### Light-Emitting Elements

The optical system can be configured to be used in combination with LEEs of one or more different nominal colors. The number, type and colour of the LEEs may provide a means for achieving high luminous efficiency, a high colour rendering index (CRI), and a large colour gamut, for example. The LEEs can be manufactured using either organic material, for example OLEDs or PLEDs or inorganic material, for example semiconductor LEDs. The LEEs can optionally be secondary light-emitting elements, which convert the emission of a primary source into broadband emission of visible light. Additionally, a combination of primary and/or secondary light-emitting elements can be provided, which can be determined based on the desired light output.

In one embodiment, the LEEs are selected having spectral outputs centred on wavelengths corresponding to the colours red, green and blue. Optionally, LEEs of other spectral output can additionally be used, for example LEEs radiating at the amber or cyan wavelength region. Choosing the types and colors of LEEs for a particular luminaire may be determined by the colour gamut and/or luminous flux range and colour rendering index intended for the illumination of the target surface.

### Groups and Arrays of LEEs

One or more groups of LEEs or arrays of LEEs or combinations thereof may be used together with optical systems according to the present invention. One or more LEEs can be aligned or arranged into a group of LEEs. For example, four LEEs including one amber, one red, one green and one blue LEE, may be considered a group of LEEs. It is noted that a group of LEEs can also include LEEs of the same color or type, for example. One or more groups of LEEs may be arranged into an array of LEEs. The LEEs of one array or one group or both may be operatively disposed onto suitable substrates which can then be used in luminaires with optical systems according to embodiments of the present invention.

A predetermined number of LEEs or groups of LEEs may be disposed per array. Each array may include a predetermined number of nominally different color LEEs. LEEs in one group of LEEs may be arranged in the same way or differently, for example, in a permuted way, as LEEs in another group of LEEs even when both groups include the same type and number of LEEs. Similarly different groups of LEEs may be arranged in a predetermined way into one array of LEEs. For example, an LEE array can include a predetermined number of groups of LEEs so that the LEEs are arranged by color, type, or power rating in a symmetrical or non-symmetrical way.

Multiple color LEEs or groups of LEEs can be positioned at and oriented in a number of directions inside each array or across the arrays in an arrangement that is random, pseudo-random, symmetrical or asymmetrical or non-symmetrical or a combination thereof. Random positioning of different color LEEs typically enables better color mixing and can provide resilience of the color and intensity uniformity of the illumination pattern provided by the luminaire against deviations of LEE characteristics from their nominal values. Random positioning can also provide for greater resilience of the color and intensity uniformity of the illumination pattern generated by the luminaire against variations in the positioning and alignment of LEEs relative to their nominal locations or directions. LEEs can be arranged, for example, in one or more rows or columns, in repetitions of triples or quadruples or other forms. The color of an LEE can be, for example, red, green, blue or amber, or other desired color.

According to one embodiment of the present invention, the optical system can be configured for an array of LEEs, wherein each of the LEEs within the array is nominally oriented in the same direction. According to another embodiment of the present invention, the optical system can be configured for an array of LEEs wherein the nominal orientation of each LEE is determined according to a predetermined pattern. In another embodiment of the present invention, the orientation of each LEE within an array is configured so that the nominal orientation of each LEE can vary randomly within a predetermined solid angle.

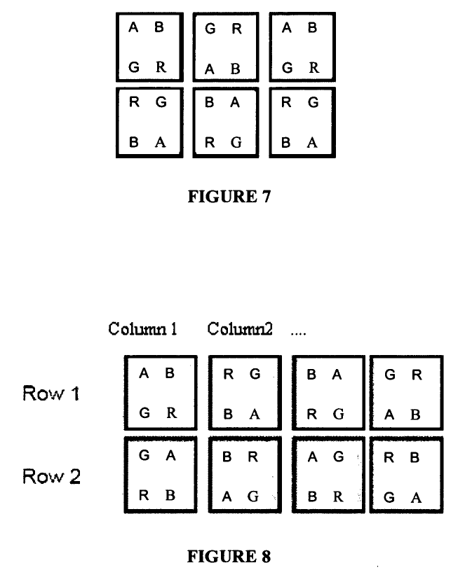

FIG. 7 and FIG. 8 illustrate different alignments of LEEs in groups of quadruples of different colour LEEs according to the present invention. FIG. 7 illustrates an array of six groups of four LEEs each with different color LEEs per group according to an embodiment of the present invention. FIG. 8 illustrates an array of eight groups of four LEEs each with different color LEEs per group according to an embodiment of the present invention.

The letters R, G, B and A in FIGS. 7, 8, 9A, 9B, 10A and 10B can indicate LEEs of different color, type, power rating and so forth. For example, R can represent a LEE for emitting red light, G can represent a LEE for emitting green light, B can represent a LEE for emitting blue light, and A can represent a LEE for emitting amber light.

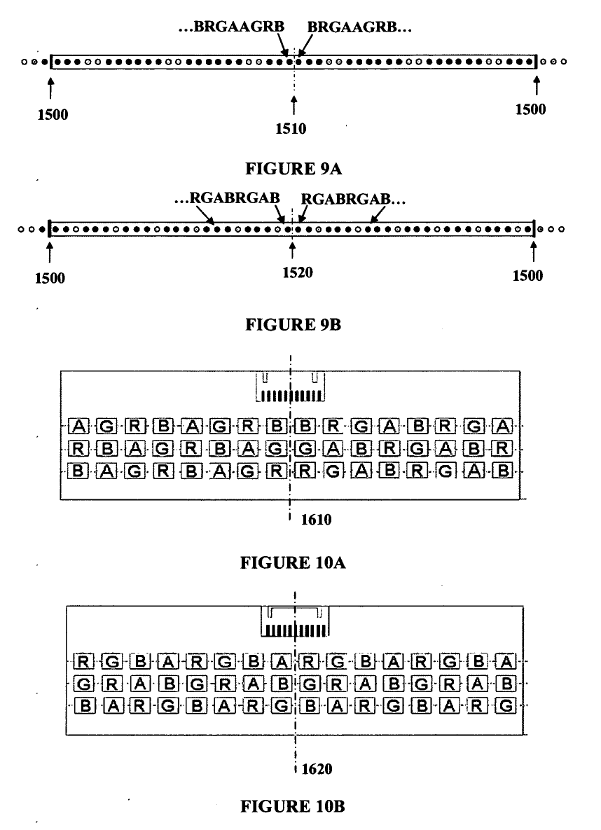

FIG. 9A and FIG. 9B illustrate arrays of LEEs with a respective symmetrical and a non-symmetrical linear alignment of different colour LEEs for use in combination with an optical system according to an embodiment of the present invention. The array of LEEs illustrated in FIG. 9A provides an axis of symmetry 1510. The LEEs in the array of LEEs illustrated in FIG. 9A are arranged in a mirror symmetric way about the axis of symmetry 1510.

The array of LEEs illustrated in FIG. 9B provides an axis of non-symmetry 1520. The LEEs in the array of LEEs illustrated in FIG. 9B are arranged in a way that is invariant under discrete translations by four LEEs within the length of the array about the axis of non-symmetry 1520. It is noted that the LEEs can be arrangements in other random non-symmetric ways. Mirrors 1500 or other reflective elements may be disposed at each end of an array of LEEs or disposed between adjacent arrays of LEEs as illustrated, for example, in FIG. 9A and FIG. 9B. The mirrors may be configured to reflect light at one or two sides, for example at opposite sides, of the mirror.

FIG. 10A and FIG. 10B illustrate examples of differently arranged arrays of LEEs with three rows of LEEs for use in combination with an optical system according to an embodiment of the present invention. The array of LEEs illustrated in FIG. 10A provides an axis of symmetry 1610. The array of LEEs illustrated in FIG. 10B provides an axis of non-symmetry 1620. It is noted that arrays of LEEs can include other numbers of rows of LEEs.

The invention will now be described with reference to particular examples. It will be understood that the following examples are intended to describe embodiments of the invention and are not intended to limit the invention in any way.

### EXAMPLES

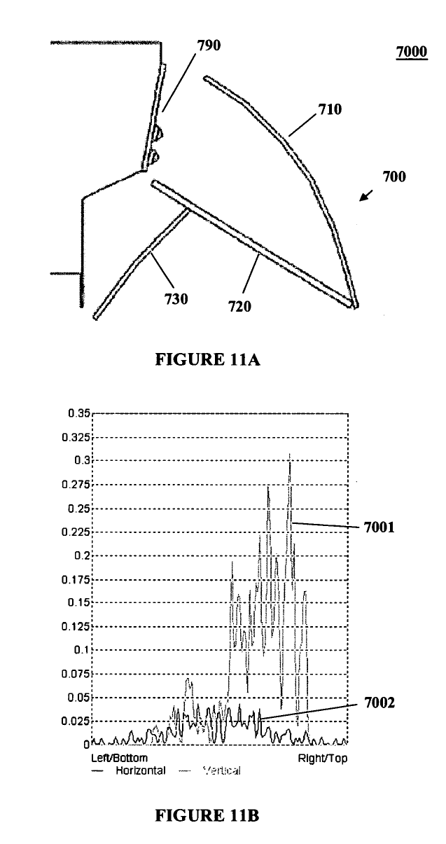

FIGS. 11A, 12A, 13A, 14A, 15A and 16A illustrate cross sections of luminaires with example optical systems according to different embodiments of the present invention. For ease of explanation, it is assumed that the illustrated luminaires are set up proximate a ceiling for purposes of illuminating a nearby wall in a generally downward or vertical direction fashion. References to vertical or horizontal directions or alignments are intended to correspond with this setup of the luminaries. It is, however, noted that the illustrated luminaires as well as other example luminaires including optical system according to embodiments of the present invention may be set up in other ways including the ones discussed and that references to indications of direction may differ from horizontal or vertical for different setups of luminaire.

FIGS. 11B, 12B, 13B, 14B, 15B and 16B illustrate intensity profiles in horizontal and in vertical directions that the respective example optical systems generate when they are disposed and aligned in a predetermined way relative to a target surface of predetermined shape and size. Each intensity profile provides, in arbitrary units, the illumination intensity integral perpendicular to the indicated direction.

### Example 1

FIG. 11A illustrates a cross-sectional view of an example luminaire 7000 comprising example optical system 700. The optical system 700 comprises first reflector 710, diffuser 720 and second reflector 730. The luminaire 7000 further comprises LEE array 790. The LEE array 790 is aligned parallel to a plane that is oblique relative to a planar to-be-illuminated target surface (not illustrated), for example, a wall. FIG. 11B illustrates the illumination intensity profile of the target surface in horizontal 7002 and in vertical 7001 directions for the luminaire 7000.

### Example 2

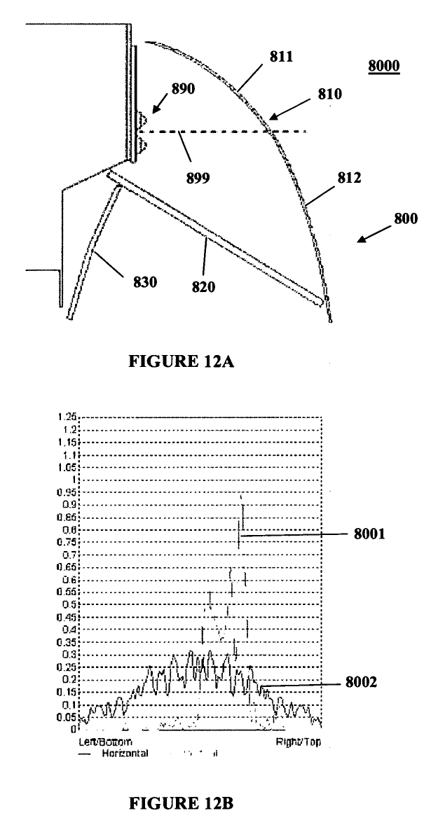

FIG. 12A illustrates a cross-sectional view of an example luminaire 8000 comprising example optical system 800. The optical system 800 comprises first reflector 810, diffuser 820 and second reflector 830. The luminaire 8000 further comprises LEE array 890. The luminaire 8000 of FIG. 12A comprises an integrally formed first reflector 810 with two different segments 811 and 812. The two segments 811 and 812 are shaped in a parabolic way and each segment corresponds to sections of a different parabola. The two segments 811 and 812 join at a line along the extension of the first reflector that lies within a plane 899 (illustrated as dashed line in the cross section of FIG. 12A) perpendicular to the LEE array 890 and intersecting the LEE array about halfway between the top row and the bottom row of LEEs as illustrated by the dashed line. The LEE array 890 is aligned parallel to the target surface. Luminaires 8000 and 7000 comprise the same type and number of LEEs but are disposed in arrays 890 and 790 which are oriented differently. FIG. 12B illustrates the illumination intensity profile of the target surface in horizontal 8002 and in vertical 8001 directions for the luminaire 8000 for a comparable setup as the setup of luminaire 7000 providing the basis for the intensity profiles of FIG. 11B. In the comparable setup of luminaires 7000 and 8000, both luminaire are similarly positioned relative to a target surface. As can be seen from FIG. 11B and FIG. 12B, luminaire 7000 generates about one third as much intensity on the target surface as luminaire 8000 as is evident from FIG. 11B and FIG. 12B for a comparable setup.

### Example 3

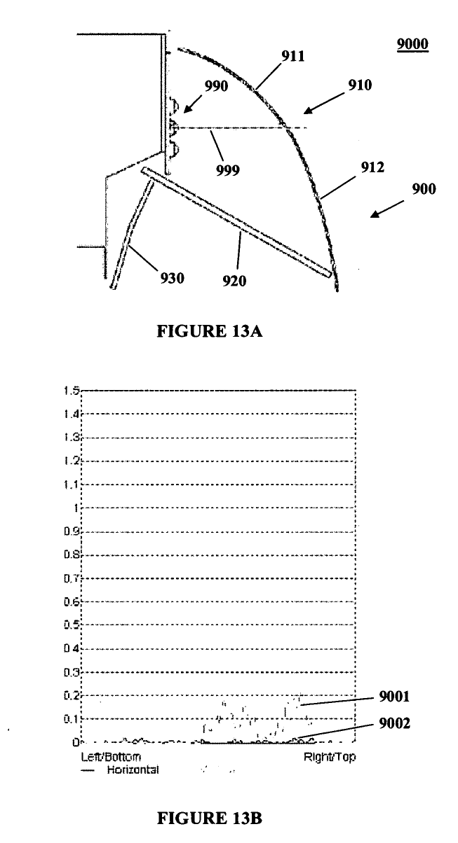

FIG. 13A illustrates a cross-sectional view of another example luminaire 9000 comprising example optical system 900. The optical system 900 comprises first reflector 910, diffuser 920 and second reflector 930. The luminaire 9000 further comprises LEE array 990 comprising three rows of LEEs. The first reflector of the illustrated embodiment is configured to provide two different parabolic segments 911 and 912. The two parabolic segments 911 and 912 join along a line that lies in a plane 999 (illustrated as dashed line in the cross section of FIG. 13A) perpendicular to the LEE array and intersecting the LEE array about halfway between the top row and bottom row of LEEs at about the position of the middle row of LEEs as illustrated by the dashed line. FIG. 13B illustrates the intensity profile in horizontal 9002 and in vertical 9001 directions for the luminaire 9000.

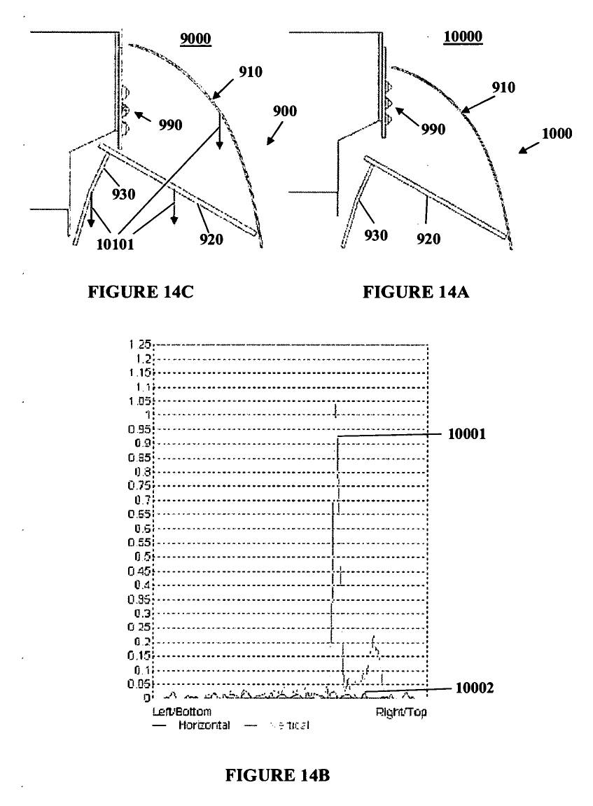

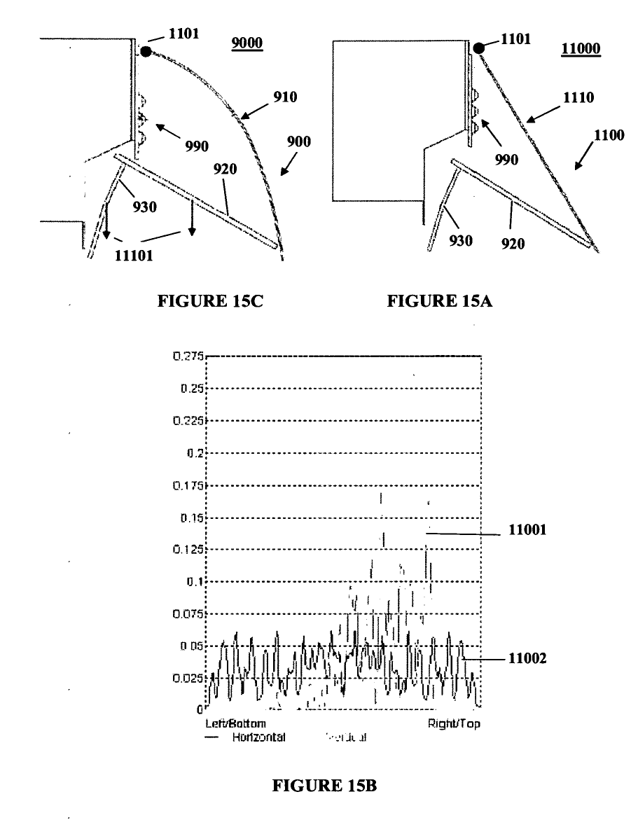

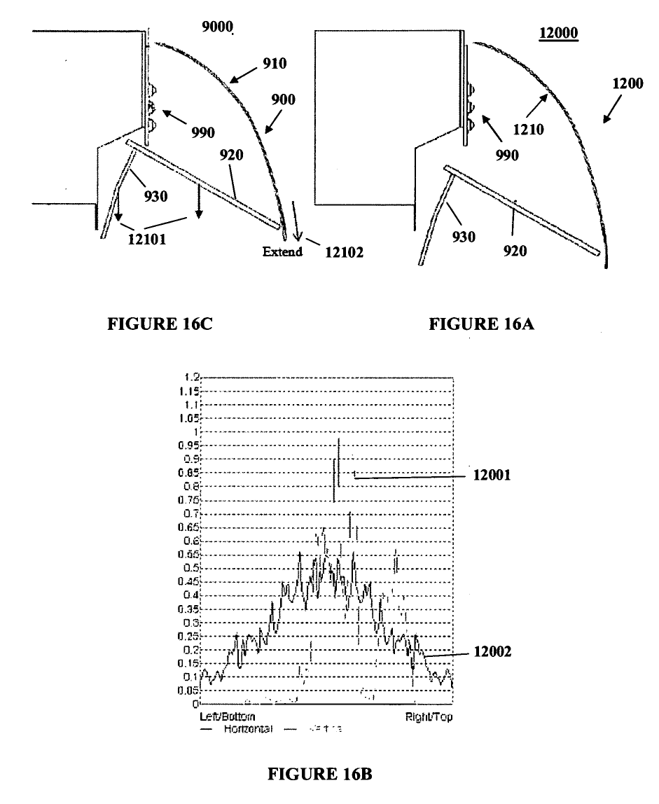

FIG. 14A, FIG. 15A and FIG. 16A illustrate cross-sectional views of further example luminaires including further example optical systems. The optical systems are positioned in different ways or aligned relative to the LEE arrays or otherwise configured as illustrated.

### Example 4

FIG. 14C illustrates the luminaire 9000 also illustrated in FIG. 13A and this is used as a reference for the positioning of the optical system associated with FIG. 14A. FIG. 14A illustrates a cross-sectional view of another example luminaire 10000 comprising the same optical system components as illustrated in FIG. 13A. However in FIG. 14A, the optical system 1000 associated with luminaire 10000 has been shifted downwardly relative to the LEE array as indicated by arrows 10101 in FIG. 14C, when compared to the luminaire 9000. FIG. 14B illustrates the intensity profile in horizontal 10002 and in vertical 10001 directions for the luminaire 10000.

### Example 5

FIG. 15C illustrates the luminaire 9000 also illustrated in FIG. 13A and this is used as a reference for the positioning of components the optical system 1100 associated with FIG. 15A. FIG. 15A illustrates a cross-sectional view of another example luminaire 11000 comprising example optical system 1100. The luminaire 11000 is similar to luminaire 9000 and comprises the same LEE array 990. The optical system 1100 includes a planar first reflector 1110, wherein the diffuser and the second reflector of luminaire 11000 are the same as that for luminaire 9000, however these components have been shifted downwardly relative to the LEE array 990, as illustrated by the arrows 11101 in FIG. 15C. FIG. 15B illustrates the intensity profile in horizontal 11002 and in vertical 11001 directions for the luminaire 11000. It is noted that optical systems according to different embodiments according the present invention, while including the same type of a planar first reflector, can also have different diffusers or different second reflectors or both different diffusers and different second reflectors.

The configuration of the optical system illustrated in FIG. 15A provides for positioning the diffuser 920 and the second reflector 930 of luminaire 11000 relatively lower to the LEE array 990 in comparison to luminaire 9000 while retaining about the same fixed position 1101 for the upper end of the first reflector. Furthermore, while the reflective surfaces of the first reflectors 910 and 1110 are differently shaped, they can have substantially the same area. FIG. 15B illustrates the intensity profile in horizontal 11002 and in vertical 11001 directions for the luminaire 11000.

### Example 6

FIG. 16C illustrates the luminaire 9000 also illustrated in FIG. 13A and this is used as a reference for the positioning of components the optical system 1200 associated with FIG. 16A. FIG. 16A illustrates a cross-sectional view of another example luminaire 12000 comprising example optical system 1200. The luminaire 12000 is similar to luminaire 9000 and comprises the same LEE array 990. The optical system 1200 includes a downwardly extended first reflector 1210, wherein the diffuser and the second reflector of luminaire 12000 are the same as that for luminaire 9000, however these components have been shifted downwardly relative to the LEE array 990, as illustrated by the arrows 12101 in FIG. 16C. In addition, the nature of the downwardly extension of the first reflector 1210, is schematically illustrated by the arrow 12102 in FIG. 16C. FIG. 16B illustrates the intensity profile in horizontal 12002 and in vertical 12001 directions for the luminaire 12000.

### Example 7

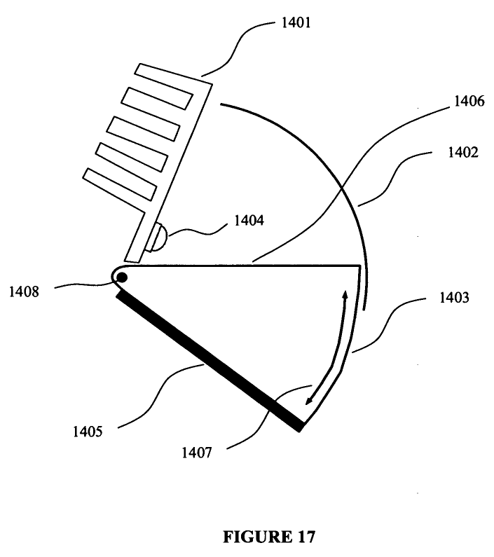

FIG. 17 illustrates an end view of another luminaire including an optical system according to one embodiment of the present invention. The luminaire comprises a heat sink 1401, which can be formed by extrusion for example, upon which is thermally and operatively mounted one or more light-emitting elements 1404. The optical system comprises a first reflector 1402 which is configured as a curved reflector. The optical system further comprises a second reflector 1403 which is pivotally movable relative to the position of the light-emitting elements 1404, via a pivot location 1408, for example. The pivotal movement of the second reflector 1403 can enable the modification of the illumination pattern generated by the luminaire, and in this embodiment of the present invention, the possible movement of the second reflector is illustrated by arrows 1407. The second reflector 1403 can be pivotally coupled to the luminaire using support struts 1406, which can be positioned at either end of the second reflector, and may further be provided at one or more additional locations along the length of the second reflector, for example. The optical system of further comprises a diffuser that is movable coupled to the support struts 1406 associated with the second reflector, and as such the diffuser can additionally be rotational movable relative to the position of the light emitting elements 1404 of the luminaire.

It is obvious that the foregoing embodiments of the invention are exemplary and can be varied in many ways. Such present or future variations are not to be regarded as a departure from the spirit and scope of the invention, and all such modifications as would be obvious to one skilled in the art are intended to be included within the scope of the following claims.

We claim:

1. An optical system for mixing and redirecting light generated by a light source, the light source disposed and oriented in a predetermined way, the optical system for illuminating a target surface, the optical system comprising:
a) a first reflector operatively disposed relative to the light source, the first reflector configured to receive first light emitted by the light source under operating conditions, the first light propagating from the light source to the reflector, the first reflector configured to reflect a portion of the first light as second light;
b) a diffuser for scattering light incident thereon, the diffuser operatively disposed and aligned relative to the first reflector, the diffuser and the first reflector configured so that at least a portion of the second light is incident upon the diffuser and is transmitted thereby as third light, the diffuser directing a portion of the third light towards the target surface;
c) a second reflector operatively disposed and aligned relative to the diffuser and the first reflector, said second reflector configured to reflect light towards the target surface;
wherein the optical system is disposed and aligned relative to the target surface in a predetermined way and configured for providing predetermined illumination to the target surface.

2. The optical system according to claim 1, wherein one or both of the first reflector and the second reflector provide a reflective surface that is configured to be symmetric under translations along a first axis within a length of the first reflector.

3. The optical system according to claim 2, wherein the diffuser is configured to be symmetric under translations along the first axis within a length of the diffuser.

4. The optical system according to claim 1, wherein the first reflector or the second reflector or both are configured as a segmented reflector.

5. The optical system according to claim 1, further comprising a third reflector for reflecting a portion of the second light.

6. The optical system according to claim 5, wherein the third reflector is configured to reflect a portion of the second light towards the second reflector or the diffuser.

7. The optical system according to claim 1, wherein the first reflector or the second reflector or both have reflective properties selected from a range including ideal diffuse to semi specular to ideal specular.

8. The optical system according to claim 1, wherein the first reflector or the second reflector or both have been configured with a finish providing an isotropic bidirectional reflectance distribution.

9. The optical system according to claim 1, wherein the first reflector or the second reflector or both have a peened reflective surface.

10. A luminaire for illuminating a target surface, the luminaire comprising:
a) one or more light-emitting elements (LEEs), the LEEs disposed and oriented in a predetermined way;
b) a first reflector operatively disposed relative to the LEEs, the first reflector configured to receive first light emitted by the LEEs under operating conditions, the first light propagating from the LEEs to the reflector, the first reflector configured to reflect a portion of the first light as second light;
c) a diffuser for scattering light incident thereon, the diffuser operatively disposed and aligned relative to the first reflector, the diffuser and the first reflector configured so that at least a portion of the second light is incident upon the diffuser and is transmitted thereby as third light, the diffuser directing a portion of the third light towards the target surface;
d) a second reflector operatively disposed and aligned relative to the diffuser and the first reflector, said second reflector configured to reflect light towards the target surface;
wherein the luminaire is disposed and aligned relative to the target surface in a predetermined way and configured for providing predetermined illumination to the target surface.

11. The luminaire according to claim 10, wherein one or both of the first reflector and the second reflector provide a reflective surface that is configured to be symmetric under translations along a first axis within a length of the first reflector.

12. The luminaire according to claim 11, wherein the diffuser is configured to be symmetric under translations along the first axis within a length of the diffuser.

13. The luminaire according to claim 10, wherein the first reflector or the second reflector of both are configured as a segmented reflector.

14. The luminaire according to claim 10, further comprising a third reflector for reflecting a portion of the second light.

15. The luminaire according to claim 14, wherein the third reflector is configured to reflect a portion of the second light towards the second reflector or the diffuser.

16. The luminaire according to claim 10, wherein the first reflector or the second reflector or both have reflective properties selected from a range including ideal diffuse to semi specular to ideal specular.

17. The luminaire according to claim 10, wherein the first reflector or the second reflector or both have a finish configured to provide an isotropic bidirectional reflectance distribution.

18. The luminaire according to claim 10, wherein the first reflector or the second reflector or both have a peened reflective surface.
